(19) United States
(12) Patent Application Publication
(10) Pub. No.: US 2025/0113270 A1
(43) Pub. Date: Apr. 3, 2025

(54) METHODS AND APPARATUSES OF A LINK MANAGEMENT AND MOBILITY FOR UL AGGREGATION

(71) Applicant: Lenovo (Beijing) Limited, Beijing (CN)

(72) Inventors: Lianhai Wu, Beijing (CN); Jing Han, Beijing (CN); Haiming Wang, Beijing (CN); Ran Yue, Beijing (CN); Min Xu, Beijing (CN); Jie Hu, Beijing (CN)

(73) Assignee: Lenovo (Beijing) Limited, Beijing (CN)

(21) Appl. No.: 18/730,165

(22) PCT Filed: Jan. 20, 2022
(86) PCT No.: PCT/CN2022/073049

§ 371 Date: Jul. 18, 2024

(51) Int. Cl. H04W 36/00

(52) U.S. Cl. CPC H04W 36/03

(57) ABSTRACT

Embodiments of the present application relate to methods and apparatuses of a link management and mobility for an uplink (UL) aggregation procedure. According to an embodiment of the present application; a user equipment (UE) includes a processor and a transceiver coupled to the processor; and the processor is configured: to access a serving cell of a network node via a direct path; to transmit, via the transceiver, information indicating whether the UE supports an uplink (UL) aggregation to the network node; and to receive, via the transceiver, a radio resource control (RRC) reconfiguration message from the network node, wherein the RRC reconfiguration message includes an indication to indicate the UE to establish an indirect path for UL aggregation. After establishing the multiple path for UL aggregation, the UE receives a radio resource control (RRC) reconfiguration message for handover.

### TECHNICAL FIELD

Embodiments of the present application generally relate to wireless communication technology, in particular to methods and apparatuses of a link management and mobility for uplink (UL) aggregation.

### BACKGROUND

Vehicle to everything (V2X) has been introduced into 5G wireless communication technology. In terms of a channel structure of V2X communication, the direct link between two user equipments (UEs) is called a sidelink. A sidelink is a long-term evolution (LTE) feature introduced in 3GPP Release 12, and enables a direct communication between proximal UEs, and data does not need to go through a base station (BS) or a core network.

In the 3rd Generation Partnership Project (3GPP), deployment of a relay node (RN) in a wireless communication system is promoted. One objective of deploying a RN is to enhance the coverage area of a BS by improving the throughput of a user equipment (UE) that is located in the coverage or far from the BS, which can result in relatively low signal quality. A RN may also be named as a relay UE in some cases. A 3GPP 5G sidelink system including a relay UE may be named as a sidelink relay system.

A remote UE is connected to network via a direct path and an indirect path in multi-path with relay, which has a potential to improve the reliability or robustness as well as throughput. This multi-path relay solution can also be utilized to for UE aggregation where a UE is connected to the network via a direct path and via another UE using a non-standardized UE-UE interconnection. UE aggregation aims to provide applications requiring high UL bitrates on 5G terminals, in cases when normal UEs are too limited by UL UE transmission power to achieve required bitrate, especially at the edge of a cell. Additionally, UE aggregation can improve the reliability, stability and reduce delay of services as well, that is, if the channel condition of a terminal is deteriorating, another terminal can be used to make up for the traffic performance unsteadiness caused by channel condition variation.

Currently, in a 3GPP 5G New Radio (NR) system or the like, details regarding how to implement a link management and mobility for UL aggregation have not been specifically discussed yet.

### SUMMARY

Some embodiments of the present application provide a user equipment (UE). The UE includes a processor and a transceiver coupled to the processor; and the processor is configured: to access a serving cell of a network node via a direct path; to transmit, via the transceiver, information indicating whether the UE supports an uplink (UL) aggregation to the network node; and to receive, via the transceiver, a radio resource control (RRC) reconfiguration message from the network node, wherein the RRC reconfiguration message includes an indication to indicate the UE to establish an indirect path for UL aggregation.

In some embodiments, the processor of the UE is configured to transmit, via the transceiver, information indicating whether there is an aggregated UE to the network node.

In some embodiments, the processor of the UE is configured to transmit, via the transceiver, an identifier (ID) of the aggregated UE. The ID of the aggregated UE may be at least one of: a medium access control (MAC) address of the aggregated UE; or a temporary mobile subscriber identity (TMSI) of the aggregated UE.

In some embodiments, the RRC reconfiguration message includes at least one of: a threshold associated with quality of service (QOS); or a reference signal received power (RSRP) threshold.

In some embodiments, the processor of the UE is configured to initiate an UL aggregation procedure once a trigger condition is met, wherein the trigger condition is at least one of: a traffic bitrate of the UE is greater than the threshold associated with QOS; and a channel quality of the UE is less than the RSRP threshold.

In some embodiments, the processor of the UE is configured to discover an aggregated UE via an unspecified link or a PC5 link.

In some embodiments, the processor of the UE is configured to transmit, via the transceiver, an identifier (ID) of the UE and an ID of the serving cell of the UE to the aggregated UE. The ID of the UE may be at least one of: a cell radio network temporary identifier (C-RNTI); layer 2 ID; or a MAC address.

In some embodiments, the processor of the UE is configured to receive, via the transceiver, an identifier (ID) of the aggregated UE an ID of a serving cell of the aggregated UE from the aggregated UE.

In some embodiments, the processor of the UE is configured to transmit, to the network node via the transceiver, the ID of the aggregated UE and a request to establish UL aggregation.

In some embodiments, the processor of the UE is configured to start to discover an aggregated UE via an unspecified link or a PC5 link after receiving the RRC reconfiguration message.

Some embodiments of the present application provide a UE. The UE includes a processor and a transceiver coupled to the processor; and the processor is configured: to access a source network node via both a direct path between the UE and the source network node and an indirect path between the UE and the source network node via an aggregated UE; to receive, via the transceiver, a RRC reconfiguration message for handover from a target network node; and to initiate a handover procedure to the target network node, wherein the aggregated UE also performs a handover procedure to the target network node.

In some embodiments, the processor of the UE is configured to receive, from the source network node or the aggregated UE via the transceiver, information indicating that the aggregated UE has successfully completed the handover procedure to the target network node. In response to that the information is received from the aggregated UE, the information may be generated by an adaptation layer of the aggregated UE.

In some embodiments, the processor of the UE is configured to start at least one of data transmission or data reception via the indirect path.

In some embodiments, the processor of the UE is configured to receive, via the transceiver, a RRC reconfiguration message including a handover command from the source network node, wherein the handover command includes an indication to indicate that the aggregated UE and the UE will handover together to the target network node.

In some embodiments, the processor of the UE is configured to perform at least one of: starting a first timer for the direct path; or starting a second timer for the indirect path.

In some embodiments, the processor of the UE is configured to stop the second timer for the indirect path in response to receiving, from the source network node or the aggregated UE, information indicating that the aggregated UE has successfully completed the handover procedure to the target network node.

In some embodiments, the processor of the UE is configured to consider that a failure occurs on the indirect path once the second timer for the indirect path expires.

Some embodiments of the present application provide an aggregated UE. The aggregated UE includes a processor and a transceiver coupled to the processor; and the processor is configured: to access a source network node via a path between the aggregated UE and the source network node; and to receive, via the transceiver, a RRC reconfiguration message including a handover command from the source network node, wherein the handover command includes an indication to indicate that the aggregated UE and the UE will handover together to a target network node.

In some embodiments, the indication is generated by the target network node. In some embodiments, the indication is transmitted from the target network node to the source network node via Xn interface.

In some embodiments, the processor of the aggregated UE is configured to initiate a handover procedure to the target network node after receiving the RRC reconfiguration message.

In some embodiments, the processor of the aggregated UE is configured to transmit, to the UE via the transceiver, information indicating that the aggregated UE has successfully completed the handover procedure, in response to successfully completing the handover procedure. The information may be generated by an adaptation layer of the aggregated UE.

Some embodiments of the present application provide a source network node (e.g., a source BS). The source network node includes a processor and a transceiver coupled to the processor; and the processor is configured: to transmit, via the transceiver, a handover request to a target network node; and to receive, via the transceiver, a handover request acknowledge message for at least one of the UE or an aggregated UE from the target network node.

In some embodiments, the handover request includes information indicating at least one of: a link between the UE and the aggregated UE is a non-3GPP standard link; or the UE and the aggregated UE have association for an uplink (UL) aggregation.

In some embodiments, the handover command includes an indication to indicate that the aggregated UE and the UE will handover together to the target network node.

In some embodiments, the indication is generated by the target network node. In some embodiments, the indication is transmitted from the target network node to the source network node via Xn interface.

In some embodiments, the processor of the source network node is configured to transmit, to at least one of the UE or the aggregated UE via the transceiver, a radio resource control (RRC) reconfiguration message including the handover command.

In some embodiments, the processor of the source network node is configured to transmit, to the UE via the transceiver, information indicating that the aggregated UE has successfully completed the handover procedure to the target network node.

Some embodiments of the present application provide a target network node (e.g., a target BS). The target network node includes a processor and a transceiver coupled to the processor; and the processor is configured: to receive, via the transceiver, a handover request from a source network node; and to transmit, via the transceiver, a handover request acknowledge message including a handover command to the source network node, wherein the handover command includes an indication to indicate that the aggregated UE and the UE will handover together to the target network node.

In some embodiments, the handover request includes information indicating at least one of: a link between the UE and the aggregated UE is a non-3GPP standard link; or the UE and the aggregated UE have association for an uplink (UL) aggregation.

In some embodiments, the indication is generated by the target network node. In some embodiments, the indication is transmitted from the target network node to the source network node via Xn interface.

Some embodiments of the present application provide an aggregated UE. The aggregated UE includes a processor and a transceiver coupled to the processor; and the processor is configured: to access a source network node via a path between the aggregated UE and the source network node; to transfer, via the transceiver, data received from the UE to the source network node; and to perform a radio resource control (RRC) re-establishment procedure after a RLF or a handover failure occurs.

In some embodiments, the processor of the aggregated UE is configured to select a same cell of the UE or other cell belonging to the source network node in priority during a cell selection operation of the RRC re-establishment procedure, in response to that the RLF or the handover failure occurs.

In some embodiments, the processor of the aggregated UE is configured to stop the RRC re-establishment procedure, in response to that the aggregated UE cannot find a suitable cell belonging to the source network node during a cell selection operation of the RRC re-establishment procedure.

In some embodiments, the processor of the aggregated UE is configured to declare the RLF before performing the RRC re-establishment procedure.

In some embodiments, the processor of the aggregated UE is configured to receive, via the transceiver, a radio resource control (RRC) reconfiguration message including a handover command from the source network node, wherein the handover command includes an indication to indicate that the aggregated UE and the UE will handover together to a target network node.

In some embodiments, the indication is generated by the target network node. In some embodiments, the indication is transmitted from the target network node to the source network node via Xn interface.

In some embodiments, the processor of the aggregated UE is configured to initiate a handover procedure to the target network node after receiving the RRC reconfiguration message.

In some embodiments, the processor of the aggregated UE is configured: to start a timer for the direct path; and to consider that the handover failure occurs once the timer for the direct path expires.

In some embodiments, only one or more cells belonging to the target network node are allowed to be selected during a cell selection operation of the RRC re-establishment procedure.

In some embodiments, the processor of the aggregated UE is configured to transmit, via the transceiver, information indicating that the aggregated UE supports an uplink (UL) aggregation to a selected suitable cell, in response to that the aggregated UE cannot determine whether the selected suitable cell belonging to the source network node.

Some embodiments of the present application provide a method, which may be performed by a UE. The method includes: accessing a serving cell of a network node via a direct path; transmitting information indicating whether the UE supports an uplink (UL) aggregation to the network node; and receiving a radio resource control (RRC) reconfiguration message from the network node, wherein the RRC reconfiguration message includes an indication to indicate the UE to establish an indirect path for UL aggregation.

In some embodiments, the method further comprises transmitting information indicating whether there is an aggregated UE to the network node.

In some embodiments, the method further comprises transmitting an identifier (ID) of the aggregated UE.

In some embodiments, the ID of the aggregated UE is at least one of: a medium access control (MAC) address of the aggregated UE; or a temporary mobile subscriber identity (TMSI) of the aggregated UE.

In some embodiments, the RRC reconfiguration message includes at least one of: a threshold associated with quality of service (QOS); or a reference signal received power (RSRP) threshold.

In some embodiments, the method further comprises initiating an UL aggregation procedure once a trigger condition is met. The trigger condition may be at least one of: a traffic bitrate of the UE is greater than the threshold associated with QoS; or a channel quality of the UE is less than the RS RP threshold.

In some embodiments, the method further comprises discovering an aggregated UE via an unspecified link or a PC5 link.

In some embodiments, the method further comprises transmitting an identifier (ID) of the UE and an ID of the serving cell of the UE to the aggregated UE.

In some embodiments, the ID of the UE is at least one of: a cell radio network temporary identifier (C-RNTI); layer 2 ID; or a MAC address.

In some embodiments, the method further comprises receiving an identifier (ID) of the aggregated UE an ID of a serving cell of the aggregated UE from the aggregated UE.

In some embodiments, the method further comprises transmitting the ID of the aggregated UE and a request to establish UL aggregation to the network node.

In some embodiments, the method further comprises starting to discover an aggregated UE via an unspecified link or a PC5 link after receiving the RRC reconfiguration message.

Some embodiments of the present application provide a method, which may be performed by a UE. The method includes: accessing a source network node via both a direct path between the UE and the source network node and an indirect path between the UE and the source network node via an aggregated UE; receiving a radio resource control (RRC) reconfiguration message for handover from a target network node; and initiating a handover procedure to the target network node, wherein the aggregated UE also performs a handover procedure to the target network node.

In some embodiments, the method further comprises receiving, from the source network node or the aggregated UE, information indicating that the aggregated UE has successfully completed the handover procedure to the target network node.

In some embodiments, in response to that the information is received from the aggregated UE, the information is generated by an adaptation layer of the aggregated UE.

In some embodiments, the method further comprises starting at least one of data transmission or data reception via the indirect path.

In some embodiments, the method further comprises receiving a RRC reconfiguration message including a handover command from the source network node, wherein the handover command includes an indication to indicate that the aggregated UE and the UE will handover together to the target network node.

In some embodiments, the method further comprises at least one of: starting a first timer for the direct path; or starting a second timer for the indirect path. In some embodiments, the method further comprises stopping the second timer for the indirect path in response to receiving, from the source network node or the aggregated UE, information indicating that the aggregated UE has successfully completed the handover procedure to the target network node. In some embodiments, the method further comprises considering that a failure occurs on the indirect path once the second timer for the indirect path expires.

Some embodiments of the present application provide a method, which may be performed by an aggregated UE. The method includes: accessing a source network node via a path between the aggregated UE and the source network node; and receiving a RRC reconfiguration message including a handover command from the source network node, wherein the handover command includes an indication to indicate that the aggregated UE and the UE will handover together to a target network node.

In some embodiments, the indication is generated by the target network node. In some embodiments, the indication is transmitted from the target network node to the source network node via Xn interface.

In some embodiments, the method further comprises initiating a handover procedure to the target network node after receiving the RRC reconfiguration message.

In some embodiments, the method further comprises, in response to successfully completing the handover procedure, transmitting, to the UE, information indicating that the aggregated UE has successfully completed the handover procedure. The information may be generated by an adaptation layer of the aggregated UE.

Some embodiments of the present application provide a method, which may be performed by a source network node. The method includes: transmitting a handover request to a target network node; and receiving a handover request acknowledge message for at least one of the UE or an aggregated UE from the target network node.

In some embodiments, the handover request includes information indicating at least one of: a link between the UE and the aggregated UE is a non-3GPP standard link; or the UE and the aggregated UE have association for an uplink (UL) aggregation.

In some embodiments, the handover command includes an indication to indicate that the aggregated UE and the UE will handover together to the target network node. In some embodiments, the indication is generated by the target network node. In some embodiments, the indication is transmitted from the target network node to the source network node via Xn interface.

In some embodiments, the method further comprises transmitting a radio resource control (RRC) reconfiguration message including the handover command to at least one of the UE or the aggregated UE.

In some embodiments, the method further comprises transmitting, to the UE, information indicating that the aggregated UE has successfully completed the handover procedure to the target network node.

Some embodiments of the present application provide a method, which may be performed by a target network node. The method includes: receiving a handover request from a source network node; and transmitting a handover request acknowledge message including a handover command to the source network node, wherein the handover command includes an indication to indicate that the aggregated UE and the UE will handover together to the target network node.

In some embodiments, the handover request includes information indicating at least one of: a link between the UE and the aggregated UE is a non-3GPP standard link; or the UE and the aggregated UE have association for an uplink (UL) aggregation.

In some embodiments, the indication is generated by the target network node. In some embodiments, the indication is transmitted from the target network node to the source network node via Xn interface.

Some embodiments of the present application provide a method, which may be performed by an aggregated UE. The method includes: accessing a source network node via a path between the aggregated UE and the source network node; transferring data received from the UE to the source network node; and performing a radio resource control (RRC) re-establishment procedure after a RLF or a handover failure occurs.

In some embodiments, the method further comprises in response to that the RLF or the handover failure occurs, selecting a same cell of the UE or other cell belonging to the source network node in priority during a cell selection operation of the RRC re-establishment procedure.

In some embodiments, the method further comprises stopping the RRC re-establishment procedure, in response to that the aggregated UE cannot find a suitable cell belonging to the source network node during a cell selection operation of the RRC re-establishment procedure.

In some embodiments, the method further comprises declaring the RLF before performing the RRC re-establishment procedure.

In some embodiments, the method further comprises receiving a RRC reconfiguration message including a handover command from the source network node, wherein the handover command includes an indication to indicate that the aggregated UE and the UE will handover together to a target network node.

In some embodiments, the indication is generated by the target network node. In some embodiments, the indication is transmitted from the target network node to the source network node via Xn interface.

In some embodiments, the method further comprises initiating a handover procedure to the target network node after receiving the RRC reconfiguration message.

In some embodiments, the method further comprises starting a timer for the direct path; and considering that the handover failure occurs once the timer for the direct path expires.

In some embodiments, only one or more cells belonging to the target network node are allowed to be selected during a cell selection operation of the RRC re-establishment procedure.

In some embodiments, the method further comprises transmitting information indicating that the aggregated UE supports an uplink (UL) aggregation to a selected suitable cell, in response to that the aggregated UE cannot determine whether the selected suitable cell belonging to the source network node.

Some embodiments of the present application also provide an apparatus for wireless communications. The apparatus includes: a non-transitory computer-readable medium having stored thereon computer-executable instructions; a receiving circuitry; a transmitting circuitry; and a processor coupled to the non-transitory computer-readable medium, the receiving circuitry and the transmitting circuitry, wherein the computer-executable instructions cause the processor to implement any of the above-mentioned methods performed by a UE, an aggregated UE, a source network node (e.g., a source BS), or a target network node (e.g., a target BS).

The details of one or more examples are set forth in the accompanying drawings and the descriptions below. Other features, objects, and advantages will be apparent from the descriptions and drawings, and from the claims.

### BRIEF DESCRIPTION OF THE DRAWINGS

In order to describe the manner in which advantages and features of the application can be obtained, a description of the application is rendered by reference to specific embodiments thereof, which are illustrated in the appended drawings. These drawings depict only example embodiments of the application and are not therefore to be considered limiting of its scope.

FIG. 1 illustrates a schematic diagram of a wireless communication system in accordance with some embodiments of the present application.

FIG. 2 illustrates an exemplary flowchart of a sidelink RRC reconfiguration procedure in accordance with some embodiments of the present application.

FIG. 3 illustrates a flow chart of an exemplary procedure of wireless communications in accordance with some embodiments of the present disclosure.

FIG. 4 illustrates a flow chart of an exemplary procedure of wireless communications in accordance with some embodiments of the present disclosure.

FIG. 5 illustrates a flow chart of an exemplary procedure of wireless communications in accordance with some embodiments of the present disclosure.

FIG. 6 illustrates a flow chart of an exemplary procedure of wireless communications in accordance with some embodiments of the present disclosure.

FIG. 7 illustrates a flow chart of an exemplary procedure of wireless communications in accordance with some embodiments of the present disclosure.

FIG. 8 illustrates a flow chart of an exemplary procedure of wireless communications in accordance with some embodiments of the present disclosure.

FIG. 9 illustrates a flow chart of an exemplary procedure of wireless communications in accordance with some embodiments of the present disclosure.

FIG. 10 illustrates an exemplary block diagram of an apparatus for UL aggregation according to some embodiments of the present application.

FIG. 11 illustrates a further exemplary block diagram of an apparatus for UL aggregation according to some embodiments of the present application.

### DETAILED DESCRIPTION

The detailed description of the appended drawings is intended as a description of preferred embodiments of the present application and is not intended to represent the only form in which the present application may be practiced. It should be understood that the same or equivalent functions may be accomplished by different embodiments that are intended to be encompassed within the spirit and scope of the present application.

Reference will now be made in detail to some embodiments of the present application, examples of which are illustrated in the accompanying drawings. To facilitate understanding, embodiments are provided under specific network architecture and new service scenarios, such as 3rd Generation Partnership Project (3GPP) LTE and LTE advanced, 3GPP 5G NR, 5G-Advanced, 6G, and so on. It is contemplated that along with developments of network architectures and new service scenarios, all embodiments in the present application are also applicable to similar technical problems; and moreover, the terminologies recited in the present application may change, which should not affect the principle of the present application.

FIG. 1 illustrates a schematic diagram of a wireless communication system in accordance with some embodiments of the present application. As illustrated and shown in FIG. 1, a wireless communication system 100 includes at least two UEs (i.e., UE 101 and aggregated UE 102) and at least one BS (e.g., BS 103) for illustrative purpose. Although a specific number of UE(s) and BS(s) are depicted in FIG. 1, it is contemplated that any number of UE(s) and BS(s) may be included in the wireless communication system 100. In some cases, UE 101 may also be named as “remote UE 101”, “a remote UE”, or the like. In some cases, aggregated UE 102 may also be named as “relay UE 102”, “a relay UE”, or the like.

As shown in FIG. 1, UE 101 may communicate with BS 103 via a direct path between UE 101 and BS 103 or via an indirect path between the UE 101 and BS 103 through aggregated UE 102. In the embodiments of the present application, a direct path is a type of UE-to-Network (U2N) transmission path, where data is transmitted between a UE and the network without sidelink relaying. An indirect path is a type of U2N transmission path, where data is forwarded via a U2N Relay UE between a U2N Remote UE and the network. A U2N Relay UE is a UE that provides functionality to support connectivity to the network for U2N Remote UE(s). A U2N Remote UE is a UE that communicates with the network via a U2N Relay UE. In the embodiments of FIG. 1, UE 101 may be a U2N Remote UE, and aggregated UE 102 may be a U2N Relay UE. As shown in FIG. 1, UE 101 may communicate with aggregated UE 102 via a PC5 link or a non-3GPP standard link.

UE(s) in the wireless communication system 100 may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), internet of things (IoT) devices, or the like. According to some embodiments of the present application, UE(s) may include a portable wireless communication device, a smart phone, a cellular telephone, a flip phone, a device having a subscriber identity module, a personal computer, a selective call receiver, or any other device that is capable of sending and receiving communication signals on a wireless network. In some embodiments of the present application, UE(s) includes wearable devices, such as smart watches, fitness bands, optical head-mounted displays, or the like. Moreover, UE(s) may be referred to as a subscriber unit, a mobile, a mobile station, a user, a terminal, a mobile terminal, a wireless terminal, a fixed terminal, a subscriber station, a user terminal, or a device, or described using other terminology used in the art. UE(s) may communicate directly with BS(s) via UL communication signals.

In some embodiments of the present application, each of UE(s) may be deployed an IoT application, an enhanced mobile broadband (eMBB) application and/or an ultra-reliable and low latency communication (URLLC) application. It is contemplated that the specific type of application(s) deployed in UE(s) may be varied and not limited.

BS(s) in the wireless communication system 100 may be distributed over a geographic region. In certain embodiments of the present application, each of BS(s) may also be referred to as an access point, an access terminal, a base, a base unit, a macro cell, a Node-B, an evolved Node B (eNB), a gNB, a NG-RAN (Next Generation-Radio Access Network) node, a Home Node-B, a relay node, or a device, or described using other terminology used in the art. BS(s) is generally a part of a radio access network that may include one or more controllers communicably coupled to one or more corresponding BS(s). Each of BS(s) may include one or more cells. Each UE(s) may perform a cell section procedure between different cell(s) of different BS(s).

The wireless communication system 100 may be compatible with any type of network that is capable of sending and receiving wireless communication signals. For example, the wireless communication system 100 is compatible with a wireless communication network, a cellular telephone network, a Time Division Multiple Access (TDMA)-based network, a Code Division Multiple Access (CDMA)-based network, an Orthogonal Frequency Division Multiple Access (OFDMA)-based network, an LTE network, a 3GPP-based network, a 3GPP 5G network, a satellite communications network, a high altitude platform network, and/or other communications networks.

In some embodiments of the present application, the wireless communication system 100 is compatible with the 5G new radio (NR) of the 3GPP protocol, wherein BS(s) transmit data using an OFDM modulation scheme on the DL and UE(s) 101 transmit data on the UL using a single-carrier frequency division multiple access (SC-FDMA) or OFDM scheme. More generally, however, the wireless communication system 100 may implement some other open or proprietary communication protocols, for example, WiMAX, among other protocols.

In some embodiments of the present application, BS(s) in the wireless communication system 100 may communicate using other communication protocols, such as the IEEE 802.11 family of wireless communication protocols. Further, in some embodiments of the present application, BS(s) may communicate over licensed spectrums, whereas in other embodiments, BS(s) may communicate over unlicensed spectrums. The present application is not intended to be limited to the implementation of any particular wireless communication system architecture or protocol. In yet some embodiments of present application, BS(s) may communicate with UE(s) using the 3GPP 5G protocols.

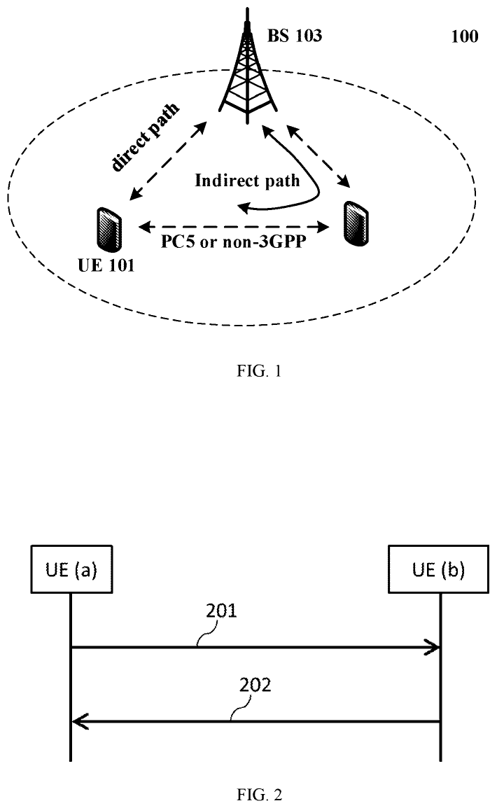

FIG. 2 illustrates an exemplary flowchart of a sidelink RRC reconfiguration procedure in accordance with some embodiments of the present application. As shown in FIG. 2, in step 201, UE (a) (e.g., UE 101 as illustrated and shown in FIG. 1) initiates a sidelink RRC reconfiguration procedure to UE (b) (e.g., aggregated UE 102 as illustrated and shown in FIG. 1) by transmitting RRCReconfigurationSidelink message to UE (b).

If the sidelink RRC reconfiguration procedure is successfully completed, in step 202, UE (b) may transmit “a RRC reconfiguration complete sidelink message” to UE (a), e.g., RRCReconfigurationCompleteSidelink message as specified in 3GPP standard documents. Alternatively, if the sidelink RRC reconfiguration procedure is not successfully completed, in step 202, UE (b) may transmit “a RRC reconfiguration failure sidelink message” to UE (a), e.g., RRCReconfigurationFailureSidelink message as specified in 3GPP standard documents.

The purpose of a sidelink RRC reconfiguration procedure is to modify a PC5 RRC connection, e.g., to establish, modify, or release sidelink data radio bearers (DRBs), to configure NR sidelink measurement and reporting, and to configure sidelink channel state information (CSI) reference signal resources.

A UE (e.g., UE (a) as illustrated and shown in FIG. 2) may initiate the sidelink RRC reconfiguration procedure and perform operations on the corresponding PC5 RRC connection in following cases:
a release of sidelink DRBs associated with a peer UE (e.g., UE (b) as illustrated and shown in FIG. 2);
an establishment of sidelink DRBs associated with the peer UE;
a modification for the parameters included in Sidelink radio bearer (SLRB)-Config of sidelink DRBs associated with the peer UE;
configuration information of the peer UE to perform NR sidelink measurement and report; and
configuration information of the sidelink CSI reference signal resources.

A UE capable of NR sidelink communication may initiate a procedure of sidelink UE information for NR, to report to a network or a BS that a sidelink radio link failure (RLF) (e.g., timer T400 expiry) or a sidelink RRC reconfiguration failure has been declared.

Embodiments of the present application aim to solve issues in a multi-path case, including a trigger condition to trigger a remote UE for requesting UL aggregation, handover configuration(s) for a combined mobility of a UE and an aggregated UE, and behaviours for an aggregated UE when a failure occurs on Uu interface. For example, some embodiments of the present application study signalling for Xn interface. Some embodiments of the present application study a mechanism for an indirect path establishment in the case of UL aggregation.

More details will be illustrated in the following text in combination with the appended drawings. Persons skilled in the art should well know that the wording “a/the first,” “a/the second” and “a/the third” etc. are only used for clear description, and should not be deemed as any substantial limitation, e.g., sequence limitation.

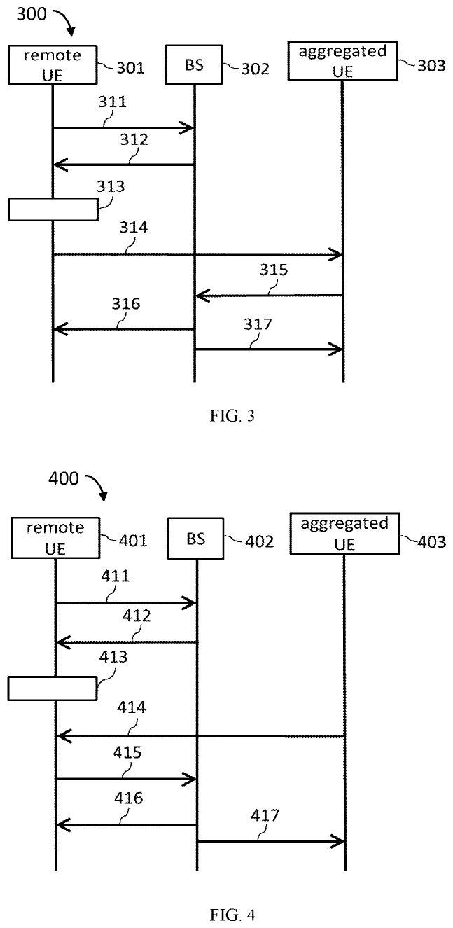

FIG. 3 illustrates a flow chart of an exemplary procedure 300 of wireless communications in accordance with some embodiments of the present disclosure. Details described in all other embodiments of the present disclosure are applicable for the embodiments shown in FIG. 3.

Exemplary procedure 300 may be applied for UL aggregation establishment. Referring to FIG. 3, remote UE 301, BS 302, and aggregated UE 303 may function as UE 101, BS 103, and aggregated UE 102 shown in FIG. 1, respectively. In particular, exemplary procedure 300 includes following steps.

In Step 311, remote UE 301 accesses the serving BS 302 via a direct path. Remote UE 301 stays at a RRC connected state. In some embodiments, remote UE 301 transmits an indication to indicate whether it supports UL aggregation to BS 302. In some embodiment, remote UE 301 transmits an indication to indicate whether there is an aggregated UE (e.g., aggregated UE 303) to BS 302. Furthermore, an ID of the aggregated UE 303, e.g., a MAC address or TMSI, may also be transmitted to BS 302. For example, the ID of the aggregated UE 303 is included in the indication transmitted to BS 302.

In Step 312, BS 302 transmits a RRC reconfiguration message to remote UE 301. In some embodiments, the RRC reconfiguration message may include the measurement configuration from BS 302. In some embodiments, the RRC reconfiguration message may include parameters related to a trigger condition. For example, the RRC reconfiguration message includes a threshold (e.g., T1) associated with QoS (e.g., a bitrate threshold) and/or a RSRP threshold (e.g., T2).

In Step 313, remote UE 301 initiates an UL aggregation procedure once the configured trigger condition is met. For instance, the configured trigger condition may be an event based trigger condition that: the bitrate of traffic of remote UE 301 is greater than the configured bitrate threshold (e.g., >T1); or the channel quality of remote UE 301 is less than the configured RSRP threshold (e.g., <T2).

In Step 314, once the configured trigger condition is met, remote UE 301 discovers aggregated UE 303 via an unspecified link or a PC5 link. Remote UE 301 may transmit its own ID and/or an ID of the serving cell of remote UE 301 to aggregated UE 303.

In Step 315, aggregated UE 303 transmits information including an ID of remote UE 301 and a request to establish UL aggregation to BS 302. In some embodiments, if the ID of the serving cell or serving BS is different, aggregated UE 303 will reject the request in Step 314 from remote UE 301. The ID of remote UE 301 could be C-RNTI, layer-2 (L2) ID, or a MAC address. In some embodiments, if aggregated UE 303 stays at an idle state, aggregated UE 303 may transit to a connected state.

In Step 316, BS 302 transmits a RRC reconfiguration message to remote UE 301. For instance, the RRC reconfiguration message may include bearer information, e.g., what bearer will be transmitted to BS 302 via aggregated UE 303. For example, the RRC reconfiguration message may include an ID of aggregated UE 303.

In Step 317, BS 302 transmits a RRC reconfiguration message to aggregated UE 303. The RRC reconfiguration message may include bearer information and the ID of remote UE 301.

It should be appreciated by persons skilled in the art that the sequence of the operations in exemplary procedure 300 in FIG. 3 may be changed and some of the operations in exemplary procedure 300 in FIG. 3 may be eliminated or modified, without departing from the spirit and scope of the disclosure.

FIG. 4 illustrates a flow chart of an exemplary procedure 400 of wireless communications in accordance with some embodiments of the present disclosure. Details described in all other embodiments of the present disclosure are applicable for the embodiments shown in FIG. 4.

Exemplary procedure 400 may be applied for UL aggregation establishment. Referring to FIG. 4, remote UE 401, BS 402, and aggregated UE 403 may function as UE 101, BS 103, and aggregated UE 102 shown in FIG. 1, respectively. Steps 411-413, 416, and 417 in exemplary procedure 400 are the same as Steps 311-313, 316, and 317 in exemplary procedure 300 in FIG. 3. In particular, exemplary procedure 400 includes following steps.

In Step 411, remote UE 401 accesses the serving BS 402 via a direct path. Remote UE 401 stays at a RRC connected state. In some embodiments, remote UE 401 transmits an indication to indicate whether it supports UL aggregation to BS 402. In some embodiment, remote UE 401 transmits an indication to indicate whether there is an aggregated UE (e.g., aggregated UE 403) to BS 402. Furthermore, an ID of the aggregated UE 403, e.g., a MAC address or TMSI, may be also transmitted to BS 402. For example, the ID of the aggregated UE 403 is included in the indication.

In Step 412, BS 402 transmits a RRC reconfiguration message to UE 401. In some embodiments, the RRC reconfiguration message may include the measurement configuration from BS 402. In some embodiments, the RRC reconfiguration message may include parameters related to a trigger condition. The RRC reconfiguration message may include a threshold (e.g., T1) associated with QoS (e.g., a bitrate threshold) and/or a RSRP threshold (e.g., T2).

In Step 413, remote UE 401 initiates an UL aggregation procedure once the configured trigger condition is met. For instance, the configured trigger condition may be an event based trigger condition that: the bitrate of traffic of remote UE 401 is greater than the configured bitrate threshold (e.g., >T1); or the channel quality of remote UE 401 is less than the configured RSRP threshold (e.g., <T2).

In Step 414, after remote UE 401 discovers aggregated UE 403 via an unspecified link, remote UE 401 can get information including an ID of aggregated UE 403 and/or an ID of the serving cell of aggregated UE 403 from aggregated UE 403. For example, the ID of aggregated UE 403 may be layer-2 (L2) UE ID, C-RNTI, or a MAC address.

In Step 415, remote UE 401 will transmit information including an ID of remote UE 301 and a request to establish UL aggregation to BS 402.

In Step 416, BS 402 transmits a RRC reconfiguration message to remote UE 401. For instance, the RRC reconfiguration message may include bearer information, e.g., what bearer will be transmitted to BS 402 via aggregated UE 403. For example, the RRC reconfiguration message may include an ID of aggregated UE 403.

In Step 417, BS 402 transmits a RRC reconfiguration message to aggregated UE 403. The RRC reconfiguration message may include bearer information and an ID of remote UE 401.

It should be appreciated by persons skilled in the art that the sequence of the operations in exemplary procedure 400 in FIG. 4 may be changed and some of the operations in exemplary procedure 400 in FIG. 4 may be eliminated or modified, without departing from the spirit and scope of the disclosure.

FIG. 5 illustrates a flow chart of an exemplary procedure 500 of wireless communications in accordance with some embodiments of the present disclosure. Details described in all other embodiments of the present disclosure are applicable for the embodiments shown in FIG. 5.

Exemplary procedure 500 refers to a trigger condition to request a configuration of an aggregated UE. Referring to FIG. 5, remote UE 501, BS 502, and aggregated UE 503 may function as UE 101, BS 103, and aggregated UE 102 shown in FIG. 1, respectively. In particular, exemplary procedure 500 includes following steps.

In Step 511, remote UE 501 accesses the serving BS 502 via a direct path. Remote UE 501 stays at a RRC connected state. In some embodiments, remote UE 501 transmits an indication to indicate whether it supports UL aggregation to BS 502. In some embodiment, remote UE 501 transmits an indication to indicate whether there is an aggregated UE (e.g., aggregated UE 503) to BS 502. Furthermore, an ID of the aggregated UE 503, e.g., a MAC address or TMSI, may be also transmitted to BS 502. In some embodiments, the ID of the aggregated UE 503 is included in the indication transmitted to BS 502. In some other embodiments, remote UE 501 separately transmits the ID of aggregated UE 503 (e.g., TMSI) to BS 502.

In Step 512, BS 502 decides to perform UL aggregation based on the traffic of remote UE 501. In Step 513, BS 502 transmits a RRC reconfiguration message including an indication of UL aggregation to remote UE 501. For example, the indication may indicate remote UE 501 to establish an indirect path for UL aggregation. The RRC reconfiguration message may include bearer information, e.g., what bearer will be transmitted to BS 502 via aggregated UE 503.

In Step 514, BS 502 transmits a RRC reconfiguration message including an indication of UL aggregation to aggregated UE 503. For example, the indication may indicate aggregated UE 503 to establish an indirect path for UL aggregation. The RRC reconfiguration message may include bearer information, e.g., what bearer will be transmitted to BS 502 via aggregated UE 503. For instance, if aggregated UE 503 stays at an idle state, BS 502 needs to firstly transmit a paging message.

In some embodiments, once remote UE 501 receives the RRC reconfiguration message including the indication of UL aggregation, remote UE 501 may start to discover aggregated UE 503 via an unspecified link or a PC5 link.

In Step 515 and Step 516, remote UE 501 transmits data to BS 502 via aggregated UE 503. The data is associated with the bearer configured by BS 502 that is transmitted via aggregated UE 503.

It should be appreciated by persons skilled in the art that the sequence of the operations in exemplary procedure 500 in FIG. 5 may be changed and some of the operations in exemplary procedure 500 in FIG. 5 may be eliminated or modified, without departing from the spirit and scope of the disclosure.

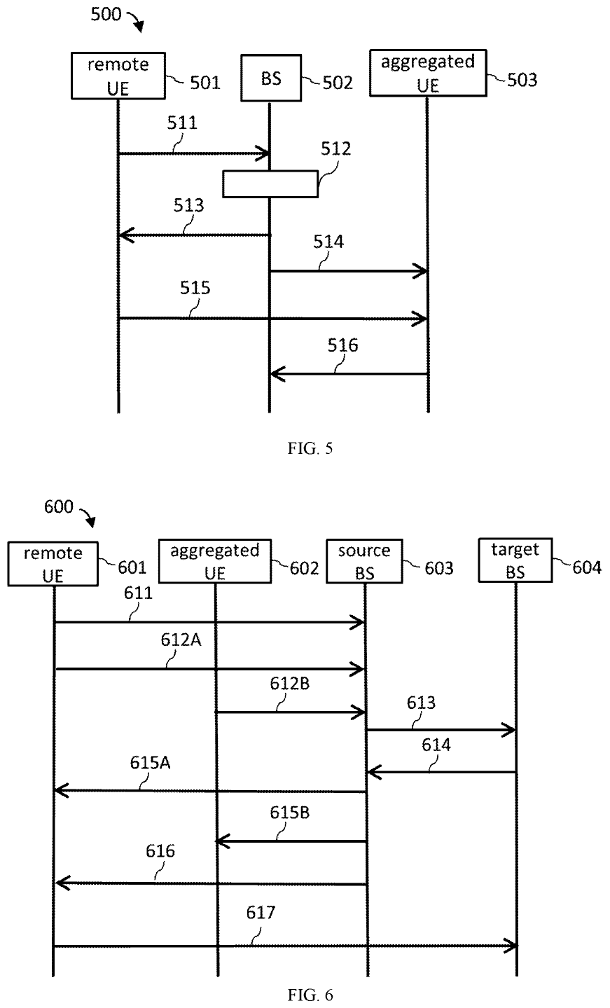

FIG. 6 illustrates a flow chart of an exemplary procedure 600 of wireless communications in accordance with some embodiments of the present disclosure. Details described in all other embodiments of the present disclosure are applicable for the embodiments shown in FIG. 6.

Exemplary procedure 600 refers to an enhanced handover configuration for the combined mobility of a UE and an aggregated UE, and also refers to an enhanced handover procedure in a case of an aggregated UE. Referring to FIG. 6, remote UE 601, aggregated UE 602, and source BS 603 may function as UE 101, aggregated UE 102, and BS 103 shown in FIG. 1, respectively. Target BS 604 may function as a target BS not shown in FIG. 1. In particular, exemplary procedure 600 includes following steps.

In Step 611, remote UE 601 accesses the serving BS 603 (also named as source BS 603) via a direct path and an indirect path. There is a common PDCP entity to receive the PDCP packet associated with this DRB from remote UE 601 and aggregated UE 602.

In Steps 612A and 612B, both remote UE 601 and aggregated UE 602 report the measurement results to source BS 603.

In Step 613, after source BS 603 decides to handover both remote UE 601 and aggregated UE 602, source BS 603 transmits a handover request to target BS 604. For example, the handover request includes at least one of: one indication that the link between remote UE 601 and aggregated UE 602 is a non-3GPP link; or one indication that remote UE 601 and aggregated UE 602 have the association for an UL aggregation procedure.

In Step 614, target BS 604 will transmit a handover request acknowledge message to source BS 603 via Xn interface. The handover request acknowledge message may include a handover command for remote UE 601 and aggregated UE 602, respectively. In some embodiments, the handover command may include an indication to indicate that remote UE 601 and aggregated UE 602 will handover together. In some embodiments, this indication is generated by target BS 604. In this case, the indication included in the RRC reconfiguration message is transferred to source BS 603 via Xn interface.

In Steps 615A and 615B, after source BS 603 receives the handover request acknowledge message from target BS 604, source BS 603 may transmit a handover command to remote UE 601 and aggregated UE 602, respectively.

In some embodiments, source BS 603 transmits the RRC reconfiguration message for handover to remote UE 601, which includes the handover command including an indication to indicate that remote UE 601 and aggregated UE 602 will handover together. Once remote UE 601 receives the RRC reconfiguration message for handover, remote UE 601 may initiate a handover procedure. In some embodiments, when remote UE 601 receives the handover command, remote UE 601 starts data transmission or data reception via a new relay link, i.e., via target relay UE.

In some embodiments, source BS 603 transmits the RRC reconfiguration message for handover to aggregated UE 602, which includes the handover command including an indication to indicate that remote UE 601 and aggregated UE 602 will handover together. Once aggregated UE 602 receives the RRC reconfiguration message for handover, aggregated UE 602 may initiate a handover procedure.

In some embodiments, after Step 615A, remote UE 601 starts a timer (e.g., timer T304) for the direct path. Remote UE 601 may start a timer for the indirect path.

In Step 616, once aggregated UE 602 successfully perform a random access procedure for handover, source BS 603 will indicate to remote UE 601. For instance, source BS 603 transmits information indicating that aggregated UE 602 has successfully completed the handover procedure (e.g., an indication of successful handover) to target BS 604.

In some embodiments, once remote UE 601 receives the indication of successful handover for aggregated UE 602, remote UE 601 stops the timer for the indirect path. In some embodiments, when remote UE 601 receives the indication of successful handover from the serving cell of source BS 603, remote UE 601 starts a data transmission or a data reception via the new relay link, i.e., via aggregated UE 602. In some embodiments, once the timer for the indirect path expires, remote UE 601 considers that the indirect path failed.

In Step 617, remote UE 601 successfully accesses target BS 604 after remote UE 601 stops the timer for the direct path (e.g., timer T304) and the timer of the indirect path.

It should be appreciated by persons skilled in the art that the sequence of the operations in exemplary procedure 600 in FIG. 6 may be changed and some of the operations in exemplary procedure 600 in FIG. 6 may be eliminated or modified, without departing from the spirit and scope of the disclosure.

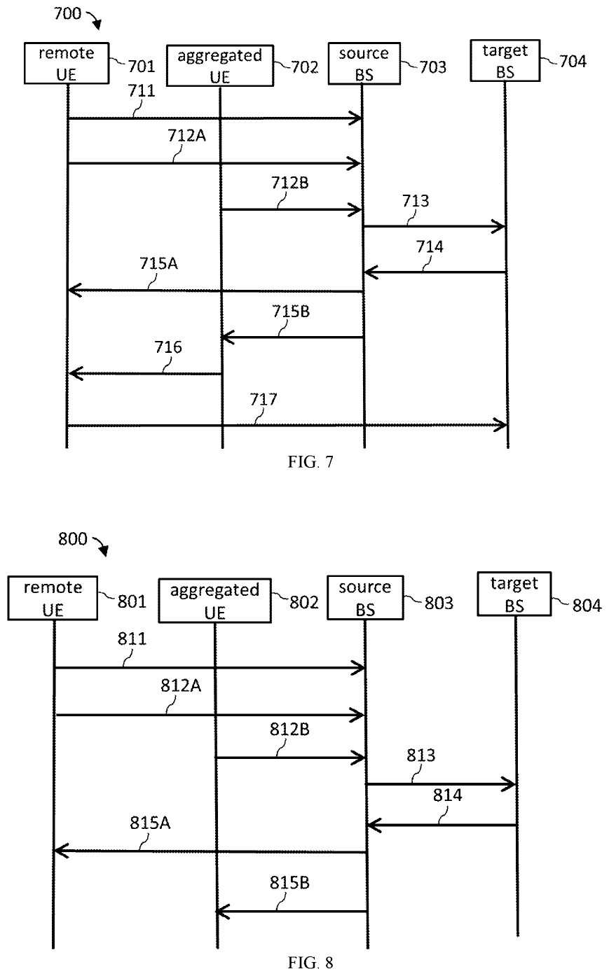

FIG. 7 illustrates a flow chart of an exemplary procedure 700 of wireless communications in accordance with some embodiments of the present disclosure. Details described in all other embodiments of the present disclosure are applicable for the embodiments shown in FIG. 7.

Exemplary procedure 700 refers to an enhanced handover configuration for the combined mobility of a UE and an aggregated UE, and also refers to an enhanced handover procedure in a case of an aggregated UE. Referring to FIG. 7, remote UE 701, aggregated UE 702, and source BS 703 may function as UE 101, aggregated UE 102, and BS 103 shown in FIG. 1, respectively. Target BS 704 may function as a target BS not shown in FIG. 1. In particular, exemplary procedure 700 includes following steps.

In Step 711, remote UE 701 accesses the serving BS 703 (may also be named as source BS 703) via a direct path and an indirect path. The indirect path is between remote UE 701 and BS 703 via aggregated UE 702. In some embodiments, for one DRB associated with UL aggregation, a PDCP packet for this DRB can be transmitted via the direct path or the indirect path. There is a common PDCP entity to receive the PDCP packet associated with this DRB from remote UE 701 and aggregated UE 702.

In Steps 712A and 712B, both remote UE 701 and aggregated UE 702 report the measurement result to source BS 703.

In Step 713, source BS 703 decides to handover both remote UE 701 and aggregated UE 702. Source BS 703 transmits a handover request to target BS 704. In some embodiments, the handover request may include one indication that the link between remote UE 701 and aggregated UE 702 is non-3GPP. In some embodiments, the handover request may include one indication that remote UE 701 and aggregated UE 702 have association for UL aggregation.

In Step 714, target BS 704 will transmit a handover request acknowledge message to source BS 703 via Xn interface. In some embodiments, the handover request acknowledge message includes a handover command for remote UE 701 and aggregated UE 702, respectively. For instance, the handover command includes an indication to indicate that remote UE 701 and aggregated UE 702 will handover together to target BS 704. The indication may be generated by target BS 704. In this case, the indication included in the RRC reconfiguration message is transferred to source BS 703 via Xn interface.

In Steps 715A and 715B, after source BS 703 receives the handover request acknowledge message from target BS 704, source BS 703 may transmit the handover command to remote UE 701 and aggregated UE 702, respectively.

In some embodiments, source BS 703 transmits the RRC reconfiguration message for handover to remote UE 701, which includes the handover command including an indication to indicate that remote UE 701 and aggregated UE 702 will handover together. Once remote UE 701 receives the RRC reconfiguration message for handover, remote UE 701 may initiate a handover procedure. In some embodiments, when remote UE 701 receives the handover command, remote UE 701 starts the data transmission or data reception via a new relay link, i.e., via target relay UE.

In some embodiments, source BS 703 transmits the RRC reconfiguration message for handover to aggregated UE 702, which includes the handover command including an indication to indicate that remote UE 701 and aggregated UE 702 will handover together. Once aggregated UE 702 receives the RRC reconfiguration message for handover, aggregated UE 702 may initiate a handover procedure.

In some embodiments, after Step 715A, remote UE 701 starts a timer (e.g., timer T304) for direct path. Remote UE 701 may start one timer for indirect path.

In Step 716, once aggregated UE 702 successfully performs random access for handover, aggregated UE 702 may transmit an indication to remote UE 701. For instance, aggregated UE 702 may transmit an indication of successful handover to indicate that aggregated UE 702 has successfully completed the handover procedure to target BS 704. The indication could be an adaptation layer control PDU. Namely, the indication is generated by adaptation layer.

In some embodiments, once remote UE 701 receives the indication of successful handover for aggregated UE 702, remote UE 701 may stop the timer for indirect path. In some embodiments, when remote UE 701 receives the indication of successful handover from aggregated UE 702, remote UE 701 starts the data transmission or data reception via a new relay link, i.e., via target relay UE. In some embodiments, once the timer expires, remote UE 701 considers that a failure occurs on the indirect path.

In Step 717, remote UE 701 successfully accesses target BS 704 after remote UE 701 stops the timer for direct path (e.g., timer T304) and the timer of indirect path.

It should be appreciated by persons skilled in the art that the sequence of the operations in exemplary procedure 700 in FIG. 7 may be changed and some of the operations in exemplary procedure 700 in FIG. 7 may be eliminated or modified, without departing from the spirit and scope of the disclosure.

FIG. 8 illustrates a flow chart of an exemplary procedure 800 of wireless communications in accordance with some embodiments of the present disclosure. Details described in all other embodiments of the present disclosure are applicable for the embodiments shown in FIG. 8.

Exemplary procedure 800 refers to enhanced behaviors for an aggregated UE when a failure happens on Uu interface. Referring to FIG. 8, remote UE 801, aggregated UE 802, and source BS 803 may function as UE 101, aggregated UE 102, and BS 103 shown in FIG. 1, respectively. Target BS 804 may function as a target BS not shown in FIG. 1. In particular, exemplary procedure 800 includes following steps.

In Step 811, remote UE 801 accesses the serving BS 803 may also be named as source BS 803) via direct path and indirect path. The indirect path is between remote UE 801 and BS 803 via aggregated UE 802. In some embodiments, for one DRB associated with UL aggregation, the PDCP packet for this DRB can be transmitted via direct path or indirect path. There is a common PDCP entity to receive the PDCP packet associated with this DRB from remote UE 801 and aggregated UE 802.

In Steps 812A and 812B, both remote UE 801 and aggregated UE 802 report the measurement result to source BS 803.

In Step 813, source BS 803 decides to handover both remote UE 801 and aggregated UE 802. Source BS 803 transmits a handover request to target BS 804. In some embodiments, the handover request includes one indication that the link between remote UE 801 and aggregated UE 802 is non-3GPP. In some embodiments, the handover request includes one indication that remote UE 801 and aggregated UE 802 have the association for UL aggregation.

In Step 814, target BS 804 will transmit a handover request acknowledge message to source BS 803 via Xn interface. In some embodiments, the handover request acknowledge message includes a handover command for remote UE 801 and aggregated UE 802, respectively. In some embodiments, the handover command includes an indication to indicate that remote UE 801 and aggregated UE 802 will handover together. This indication may be generated by target BS 804. In this case, the indication included in the RRC reconfiguration message is transferred to source BS 803 via Xn interface.

In Steps 815A and 815B, after source BS 803 receives the handover request acknowledge message from target BS 804, source BS 803 will transmit the handover command to remote UE 801 and aggregated UE 802, respectively. In some embodiments, source BS 703 transmits the RRC reconfiguration message for handover to remote UE 801, which includes the handover command including an indication to indicate that remote UE 801 and aggregated UE 802 will handover together. In some embodiments, source BS 803 transmits the RRC reconfiguration message for handover to aggregated UE 802, which includes the handover command including an indication to indicate that remote UE 801 and aggregated UE 802 will handover together.

In some embodiments, once aggregated UE 802 receives the RRC reconfiguration message for handover, aggregated UE 802 initiates a handover procedure.

In some embodiments, aggregated UE 802 starts a timer (e.g., timer T304) for the direct path.

In some embodiments, once the timer (e.g., timer T304) for relay expires, aggregated UE 802 performs a RRC re-establishment procedure. In some embodiments, there may be following four options:
1) Option 1: Once a RLF happens on aggregated UE 802's Uu interface, aggregated UE 802 indicates to remote UE 801 and performs a RRC re-establishment procedure. Aggregated UE 802 may select the same cell or other cell belonging to the same BS in priority during a cell selection operation.
2) Option 2: If aggregated UE 802 cannot find a suitable cell belonging to the same BS, aggregated UE 802 may stop the RRC re-establishment procedure if aggregated UE 802 has no own traffic.
3) Option 3: Only cell(s) belonging to the same BS are allowed to be selected during a cell selection operation of the RRC re-establishment procedure.
4) Option 4: If aggregated UE 802 cannot determine whether the selected suitable cell belonging to the same BS, aggregated UE 802 needs to transmit information about aggregated purpose to the selected cell. For example, aggregated UE 802 transmits information to indicate that aggregated UE 802 supports UL aggregation. Then, the selected cell will trigger a handover procedure to the preferred cell.

It should be appreciated by persons skilled in the art that the sequence of the operations in exemplary procedure 800 in FIG. 8 may be changed and some of the operations in exemplary procedure 800 in FIG. 8 may be eliminated or modified, without departing from the spirit and scope of the disclosure.

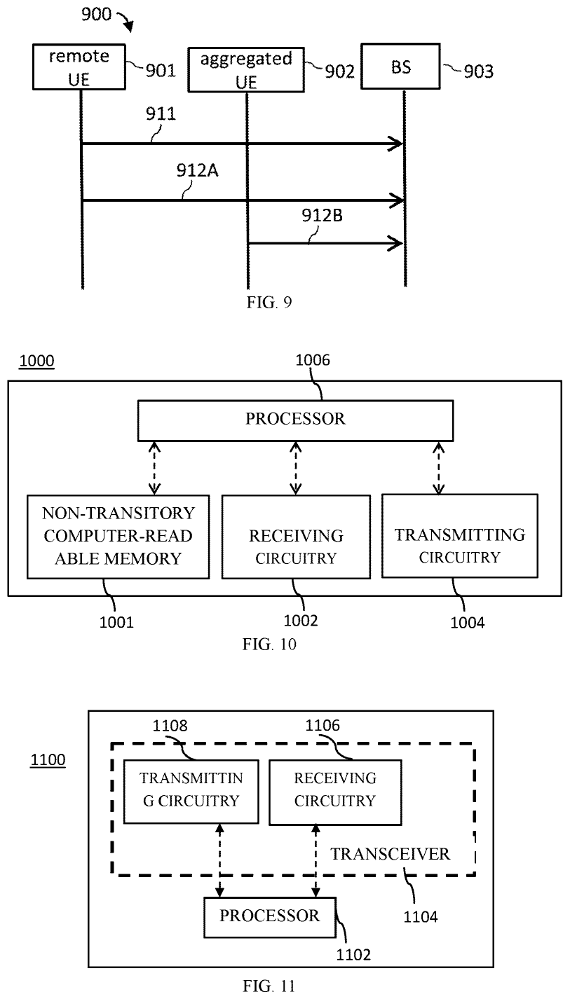

FIG. 9 illustrates a flow chart of an exemplary procedure 900 of wireless communications in accordance with some embodiments of the present disclosure. Details described in all other embodiments of the present disclosure are applicable for the embodiments shown in FIG. 9.

Exemplary procedure 900 refers to enhanced behaviors for an aggregated UE when a failure happens on Uu interface. Referring to FIG. 9, remote UE 901, BS 902, and aggregated UE 903 may function as UE 101, BS 103, and aggregated UE 102 shown in FIG. 1, respectively. In particular, exemplary procedure 900 includes following steps.

In Step 911, remote UE 901 accesses the serving BS 903 via a direct path and an indirect path. The indirect path is between remote UE 901 and BS 903 via aggregated UE 902. In some embodiments, for one DRB associated with UL aggregation, a PDCP packet for this DRB can be transmitted via direct path or indirect path. There is a common PDCP entity to receive the PDCP packet associated with this DRB from remote UE 901 and aggregated UE 902.

In Steps 912A and 912B, both remote UE 901 and aggregated UE 902 report the measurement results to BS 903.

In some embodiments, aggregated UE 902 may declare a RLF. After that, aggregated UE 902 may perform a RRC re-establishment procedure. In some embodiments, there may be following four options:
1) Option 1: Once a RLF happens on aggregated UE 902's Uu interface, aggregated UE 902 indicates to remote UE 901 and performs a RRC re-establishment procedure. Aggregated UE 902 may select the same cell or other cell belonging to the same BS in priority during a cell selection operation.
2) Option 2: If aggregated UE 902 cannot find a suitable cell belonging to the same BS, aggregated UE 902 may stop the RRC re-establishment procedure if aggregated UE 902 has no own traffic.
3) Option 3: Only cell(s) belonging to the same BS are allowed to be selected during a cell selection operation of the RRC re-establishment procedure.
4) Option 4: If aggregated UE 902 cannot determine whether the selected suitable cell belonging to the same BS, aggregated UE 902 needs to transmit the information about aggregated purpose to the selected cell. For example, aggregated UE 902 transmits information to indicate that aggregated UE 902 supports UL aggregation. Then, the selected cell will trigger a handover procedure to the preferred cell.

It should be appreciated by persons skilled in the art that the sequence of the operations in exemplary procedure 900 in FIG. 9 may be changed and some of the operations in exemplary procedure 900 in FIG. 9 may be eliminated or modified, without departing from the spirit and scope of the disclosure.

Some embodiments of the present application also provide a wireless communication apparatus of a link management and mobility for UL aggregation. For example, FIG. 10 illustrates an exemplary block diagram of an apparatus for UL aggregation 1000 according to some embodiments of the present application.

As shown in FIG. 10, the apparatus 1000 may include at least one non-transitory computer-readable medium 1001, at least one receiving circuitry 1002, at least one transmitting circuitry 1004, and at least one processor 1006 coupled to the non-transitory computer-readable medium 1001, the receiving circuitry 1002 and the transmitting circuitry 1004. The at least one processor 1006 may be a CPU, a DSP, a microprocessor etc. The apparatus 1000 may be a network apparatus (a source BS or a target BS) or a UE (a remote UE or an aggregated UE) configured to perform a method illustrated in the above or the like.

Although in this figure, elements such as the at least one processor 1006, transmitting circuitry 1004, and receiving circuitry 1002 are described in the singular, the plural is contemplated unless a limitation to the singular is explicitly stated. In some embodiments of the present application, the receiving circuitry 1002 and the transmitting circuitry 1004 can be combined into a single device, such as a transceiver. In certain embodiments of the present application, the apparatus 1000 may further include an input device, a memory, and/or other components.

In some embodiments of the present application, the non-transitory computer-readable medium 1001 may have stored thereon computer-executable instructions to cause a processor to implement the method with respect to the network apparatus, e.g., a BS, as described above. For example, the computer-executable instructions, when executed, cause the processor 1006 interacting with receiving circuitry 1002 and transmitting circuitry 1004, so as to perform the steps with respect to a network apparatus, e.g., a BS, as depicted above.

In some embodiments of the present application, the non-transitory computer-readable medium 1001 may have stored thereon computer-executable instructions to cause a processor to implement the method with respect to a UE as described above. For example, the computer-executable instructions, when executed, cause the processor 1006 interacting with receiving circuitry 1002 and transmitting circuitry 1004, so as to perform the steps with respect to a UE as illustrated above.

FIG. 11 illustrates a further exemplary block diagram of an apparatus for UL aggregation 1100 according to some embodiments of the present application.

Referring to FIG. 11, the apparatus 1100, for example a BS or a UE may include at least one processor 1102 and at least one transceiver 1104 coupled to the at least one processor 1102. The transceiver 1104 may include at least one separate receiving circuitry 1106 and transmitting circuitry 1108, or at least one integrated receiving circuitry 1106 and transmitting circuitry 1108. The at least one processor 1102 may be a CPU, a DSP, a microprocessor etc.

According to some embodiments of the present application, when the apparatus 1100 is a UE, the processor 1102 may be configured: to access a serving cell of a network node via a direct path; to transmit, via the transceiver 1104, information indicating whether the UE supports an UL aggregation to the network node; and to receive, via the transceiver 1104, a RRC reconfiguration message from the network node, wherein the RRC reconfiguration message includes an indication to indicate the UE to establish an indirect path for UL aggregation.

According to some other embodiments of the present application, when the apparatus 1100 is a UE, the processor 1102 may be configured: to access a source network node via both a direct path between the UE and the source network node and an indirect path between the UE and the source network node via an aggregated UE; to receive, via the transceiver 1104, a RRC reconfiguration message for handover from a target network node; and to initiate a handover procedure to the target network node, wherein the aggregated UE also performs a handover procedure to the target network node.

According to some other embodiments of the present application, when the apparatus 1100 is an aggregated UE, the processor 1102 may be configured: to access a source network node via a path between the aggregated UE and the source network node; and to receive, via the transceiver 1104, a RRC reconfiguration message including a handover command from the source network node, wherein the handover command includes an indication to indicate that the aggregated UE and the UE will handover together to a target network node.

According to some other embodiments of the present application, when the apparatus 1100 is an aggregated UE, the processor 1102 may be configured: to access a source network node via a path between the aggregated UE and the source network node; to transfer, via the transceiver 1104, data received from the UE to the source network node; and to perform a RRC re-establishment procedure after a RLF or a handover failure occurs.

According to some embodiments of the present application, when the apparatus 1100 is a source BS, the processor 1102 is configured: to transmit, via the transceiver 1104, a handover request to a target network node; and to receive, via the transceiver 1104, a handover request acknowledge message for at least one of the UE or an aggregated UE from the target network node.

According to some embodiments of the present application, when the apparatus 1100 is a target BS, the processor 1102 is configured: to receive, via the transceiver 1104, a handover request from a source network node; and to transmit, via the transceiver 1104, a handover request acknowledge message including a handover command to the source network node, wherein the handover command includes an indication to indicate that the aggregated UE and the UE will handover together to the target network node.

The method(s) of the present disclosure can be implemented on a programmed processor. However, controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device that has a finite state machine capable of implementing the flowcharts shown in the figures may be used to implement the processing functions of the present disclosure.

While this disclosure has been described with specific embodiments thereof, it is evident that many alternatives, modifications, and variations may be apparent to those skilled in the art. For example, various components of the embodiments may be interchanged, added, or substituted in the other embodiments. Also, all of the elements of each figure are not necessary for operation of the disclosed embodiments. For example, those having ordinary skills in the art would be enabled to make and use the teachings of the disclosure by simply employing the elements of the independent claims. Accordingly, embodiments of the disclosure as set forth herein are intended to be illustrative, not limiting. Various changes may be made without departing from the spirit and scope of the disclosure.

In this document, the terms “includes,” “including,” or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that includes the element. Also, the term “another” is defined as at least a second or more. The term “having” and the like, as used herein, are defined as “including.

1. A user equipment (UE) for wireless communication, comprising:
at least one memory; and
at least one processor coupled with the at least one memory and configured to cause the UE to:
access a source network node via both a direct transmission path between the UE and the source network node and an indirect transmission path between the UE and the source network node via an aggregated UE;
receive, from a target network node, a radio resource control (RRC) reconfiguration message for handover; and
initiate a handover procedure to the target network node, wherein the aggregated UE also performs the handover procedure to the target network node.

2. The UE of claim 1, wherein the at least one processor is configured to cause the UE to receive, from the source network node or the aggregated UE, information indicating that the aggregated UE has successfully completed the handover procedure to the target network node.

3. The UE of claim 2, wherein the information received from the aggregated UE is generated by an adaptation layer of the aggregated UE.

4. The UE of claim 1, wherein the at least one processor is configured to cause the UE to start at least one of data transmission or data reception via the indirect transmission path.

5. The UE of claim 1, wherein the at least one processor is configured to cause the UE to receive the RRC reconfiguration message including a handover command from the source network node, wherein the handover command includes an indication that the aggregated UE and the UE will handover together to the target network node.

6. The UE of claim 5, wherein the at least one processor of the UE is configured to cause the UE to perform at least one of:
starting a first timer for the direct transmission path; or
starting a second timer for the indirect transmission path.

7. The UE of claim 6, wherein the at least one processor is configured to cause the UE to stop the second timer for the indirect transmission path in response to receiving, from the source network node or the aggregated UE, information indicating that the aggregated UE has successfully completed the handover procedure to the target network node.

8. The UE of claim 6, wherein the at least one processor is configured to cause the UE to consider that a failure occurs on the indirect transmission path once the second timer for the indirect transmission path expires.

9. An aggregated user equipment (UE) for wireless communication, comprising:
at least one memory; and
at least one processor coupled with the at least one memory and configured to cause the aggregated UE to:
access a source network node via a transmission path between the aggregated UE and the source network node; and
receive, from the source network node, a radio resource control (RRC) reconfiguration message including a handover command, wherein the handover command includes an indication that the aggregated UE and an additional UE will handover together to a target network node.

10. The aggregated UE of claim 9, wherein the indication is generated by the target network node, and the indication is transmitted from the target network node to the source network node via Xn interface.

11. (canceled)

12. The aggregated UE of claim 9, wherein the at least one processor is configured to cause the aggregated UE to initiate a handover procedure to the target network node based on receiving the RRC reconfiguration message.

13. The aggregated UE of claim 12, wherein the at least one processor is configured to cause the aggregated UE to transmit, to the additional UE, information indicating that the aggregated UE has successfully completed the handover procedure, in response to successfully completing the handover procedure.

14. The aggregated UE of claim 13, wherein the information is generated by an adaptation layer of the aggregated UE.

15. (canceled)

16. A user equipment (UE) for wireless communication, comprising:
at least one memory; and
at least one processor coupled with the at least one memory and configured to cause the UE to:
access a serving cell of a network node via a direct transmission path;
transmit, to the network node, first information indicating whether the UE supports an uplink (UL) aggregation; and
receive, from the network node, a radio resource control (RRC) reconfiguration message that includes an indication to the UE to establish an indirect transmission path for the UL aggregation.

17. The UE of claim 16, wherein the at least one processor is configured to cause the UE to transmit, to the network node, second information indicating whether there is an aggregated UE.

18. The UE of claim 17, wherein the at least one processor is configured to cause the UE to transmit an identifier (ID) of the aggregated UE.

19. The UE of claim 17, wherein the at least one processor is configured to cause the UE to transmit, to the network node, an identifier (ID) of the aggregated UE and a request to establish the UL aggregation.

20. A processor for wireless communication, comprising:
at least one controller coupled with at least one memory and configured to cause the processor to:
access a serving cell of a network node via a direct transmission path;
transmit, to the network node, first information indicating whether a user equipment (UE) supports an uplink (UL) aggregation; and
receive, from the network node, a radio resource control (RRC) reconfiguration message that includes an indication to the UE to establish an indirect transmission path for the UL aggregation.

21. The processor of claim 20, wherein the at least one controller is configured to cause the processor to transmit, to the network node, second information indicating whether there is an aggregated UE.

22. The processor of claim 21, wherein the at least one controller is configured to cause the processor to transmit, to the network node, an identifier (ID) of the aggregated UE and a request to establish the UL aggregation.
